(19) United States
(12) Patent Application Publication
(10) Pub. No.: US 2003/0196096 A1
(43) Pub. Date: Oct. 16, 2003

(54) Microcode patch authentication

(76) Inventor: James A. Sutton, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/121,807

(22) Filed: Apr. 12, 2002

(51) Int. Cl. H04L 9/00

(52) U.S. Cl. 713/181; 713/176

(57) ABSTRACT

Microcode patches are encoded before delivery to a target processor that is to install the microcode patches. The target processor validates the microcode patches before installation. The security of the process may be enhanced by one or more of: 1) performing the validation in a secure memory, 2) using a public/private key pair for encryption and decryption of the microcode patch, 3) using at least one key that is embedded in the target processor and that cannot be read by non-secure software, and 4) using a hash value that is embedded in the target processor to validate at least one non-embedded key.

### BACKGROUND

A typical instruction in a computer processor performs a series of operations, with microinstructions that define each operation being encoded in a non-volatile storage area in the form of microcode. The microcode defines all or a portion of the executable instruction set for the processor, and may also define internal operations that are not implemented in software-accessible code. The microcode is typically placed in a read-only memory (ROM) within the processor at the time the processor is manufactured. However, microcode sometimes needs to be modified after the processor is manufactured, and even after the processor has been placed into operation. Microcode patches allow such modification by inserting new microinstructions in place of the original microinstructions. The microcode patches can be delivered to the processor in various ways (such as by being downloaded over a communications channel, installed by a service technician, or provided with an operating system), and are then stored in the processor for operational use. Since the microcode ROM cannot be easily altered, microcode patches are typically placed into a patch memory within the processor, such as a random-access memory (RAM), and references to the modified microinstructions are redirected into the patch RAM rather than the ROM. Because the patch RAM may be volatile, the microcode patches are usually stored either on disk or in the Basic Input-Output System (BIOS), and are loaded into the patch RAM when the system is booted.

If a processor is to be used in a secure environment, various security measures should be taken in the design of the software and/or hardware to provide protection against tampering with the operation of the secure features. The ability to insert unauthorized microcode patches into a processor represents one way that a hostile attacker may thwart conventional security measures.

### BRIEF DESCRIPTION OF THE DRAWINGS

The invention may be understood by referring to the following description and accompanying drawings that are used to illustrate embodiments of the invention.

FIG. 1 shows a block diagram of a system to validate and install microcode patches, according to one embodiment of the invention.

FIG. 2 shows a block diagram of a system to convert microcode patches into a secure form for delivery, according to one embodiment of the invention.

FIG. 3 shows a patch package containing elements delivered from the system of FIG. 2 to the system of FIG. 1, according to one embodiment of the invention.

FIG. 4 shows a flow chart of an overall process for preparing, delivering, and validating a patch package, according to one embodiment of the invention.

FIG. 5 shows a flow chart of a process for preparing a patch package, according to one embodiment of the invention.

FIG. 6 shows a flow chart of a process for validating a patch package, according to one embodiment of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure an understanding of this description. References to “one embodiment”, “an embodiment”, “example embodiment”, “various embodiments”, etc., indicate that the embodiment(s) described may include a particular feature, structure, or characteristic, but not every embodiment necessarily includes the particular feature, structure, or characteristic. Also, the features, structures, or characteristics described for different embodiments may be combined into a single embodiment. Further, repeated use of the phrase “in one embodiment” does not necessarily refer to the same embodiment, although it may.

References herein to cryptography may include one or both of encryption and decryption. References herein to “symmetric” cryptography, keys, encryption, or decryption, refer to cryptographic techniques in which the same key is used for encryption and the associated decryption. The well known Data Encryption Standard (DES) published in 1993 as Federal Information Publishing Standard FIPS PUB 46-2, and Advanced Encryption Standard (AES), published in 2001 as FIPS PUB 197, are examples of symmetric cryptography. Reference herein to “asymmetric” cryptography, keys, encryption, or decryption, refer to cryptographic techniques in which different but related keys are used for encryption and the associated decryption. So called “public key” cryptographic techniques, including the well-known Rivest-Shamir-Adleman (RSA) technique, are examples of asymmetric cryptography. One of the two related keys of an asymmetric cryptographic process is referred to herein as a private key (because it is generally kept secret), and the other key is referred to as a public key (because it is generally made freely available). In some embodiments either the private or public key may be used for encryption while the other key is used for the associated decryption.

Embodiments of the invention may be implemented in one or a combination of hardware, firmware, and software. Embodiments of the invention may also be implemented as instructions stored on a machine-readable medium, which may be read and executed by at least one processor to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.), and others.

Various embodiments of the invention involve the encoding and/or decoding of a microcode patch (also referred to herein simply as a ‘patch’) so that the patch can be authenticated as valid before being installed in a target processor (a processor in which the patch is intended to be used). Encoding/decoding may include one or more of: 1) encryption/decryption, 2) the use of cryptographic hash functions, 3) the use of digital signatures, 4) etc. A target system is the system in which the patch is to be installed, while an originating system is the system that prepares the patch for secure delivery to the target system. In one embodiment, a common set of patches is produced for a particular type of computer system, where “type” may indicate a particular generation, a particular model number, some category within the model number, etc. Once a patch is produced, it may be encoded in the manner described herein before delivery to each of the target systems for which it is intended. Within each target system, one or more patches may be decoded and installed as described herein so that the patches become an operational part of the target system.

Any convenient method of delivery may be used, including but not limited to delivery over a communications link, installation by a technician, inclusion in an operating system by the manufacturer of that operating system, inclusion in a basic input output system (BIOS), etc. Once delivered, the patch may be stored in its encoded form until it is operationally installed. Operational installation includes decoding the encoded patch, validating that the patch is authorized, and placing the patch into a patch memory. Validating may include either or both of: 1) determining that the patch has not been modified since it was prepared for delivery in the origination system, and 2) determining that the patch was prepared in an authorized system. In one embodiment, the encoded patch is stored on disk or in the BIOS of the target system, to be operationally installed in volatile patch RAM each time the system is booted. In another embodiment, the encoded patch is operationally installed in non-volatile patch memory and is not reinstalled during subsequent reboots.

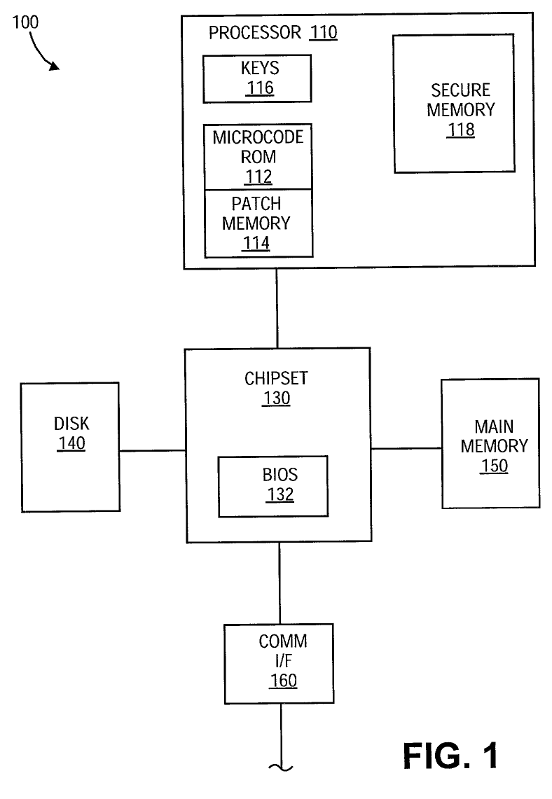

FIG. 1 shows a block diagram of a system to validate and install microcode patches, according to one embodiment of the invention. In the illustrated embodiment of FIG. 1, system 100 includes a processor 110, chipset 130, disk 140, main memory 150, and communications interface (Comm I/F) 160. Processor 110 may include microcode ROM 112, a patch memory 114, a secure memory 118, and one or more keys 116. Chipset 130 may include BIOS 132. A patch package, described later, may be stored in at least one of disk 140, BIOS 132, or another part of system 100 that includes non-volatile storage.

In some embodiments, the operations of decoding, validating and installing the patch may be performed by a sequence of microinstructions contained in microcode ROM 112. In a particular embodiment the sequence is initiated by executing a special instruction that transfers execution to the entry point of the sequence. In another particular embodiment the sequence is initiated in response to writing a predetermined value to a predetermined section of a machine-specific register (MSR). Other methods may also be used to initiate the sequence.

The data being operated upon during the decoding, validating and installing of the patch may be located in secure memory 118, which may be secured in a manner that makes it unavailable for access by non-secure code. In some embodiments secure memory 118 may contain, at various times, the encoded patch, the decoded patch, and interim products created during decoding of the encoded patch. In one embodiment, secure memory 118 does not have enough capacity to hold all of the aforementioned patches and/or interim products, and may simultaneously contain only portions of one or more of the encoded patch, decoded patch, and the interim products.

In one embodiment, secure memory 118 is a dedicated RAM memory which may be disposed either inside or outside of processor 110, that is used only for secure operations. In another embodiment, secure memory 118 is a dedicated cache of processor 110, and access to the dedicated cache is blocked to all other operations during the decoding, validating, and installing of the patch. Other embodiments may use other methods of providing secure memory 118 during the described operations.

Although system 100 illustrates a particular embodiment, other embodiments may also be used. For example, in one embodiment, BIOS 132 may be included in processor 110, and another embodiment may not have a chipset 130.

In one embodiment, keys 116 are one or more security keys (values that are used in encoding and/or decoding) that have been embedded in processor 110. “Embedded” keys are manufactured into the processor 110 in a manner that prevents them from being changed by system 100's software and that prevents them from being read by non-secure software. In a particular embodiment, embedded keys may not be read directly by any software, but one or more particular instructions may cause a specific embedded key to be transferred into other hardware for use in a decoding sequence.

In one embodiment, a particular embedded key is one of the two keys for an asymmetric cryptographic algorithm, with the other of the two keys being kept in the patch origination system under secure control. In another embodiment, a particular embedded key includes a hash value of a public key for an asymmetric cryptographic algorithm, the public key being delivered with the associated patch. Other embodiments may include other types of keys as embedded keys.

In some embodiments, microcode 112 is located in non-volatile storage such as read only memory (ROM) and cannot be directly altered after manufacture. A patch may be placed in patch memory 114 for system operation so that in response to a reference to a section of modified microcode, the reference is redirected to patch memory 114 to access the modified microcode. In one embodiment patch memory 114 includes RAM, and the patch is installed in the RAM of patch memory 114 each time the system 100 is reset and/or rebooted. In another embodiment patch memory 114 includes a non-volatile form of memory such as flash memory, and once installed, each patch remains intact in patch memory 114 until the patch is replaced by a subsequent patch.

Before installation, an encoded patch may be stored in non-volatile memory such as the BIOS 132 or on disk 140, to be decoded and validated each time the patch is installed in patch memory 114. In one embodiment, a patch from a BIOS vendor may be stored in BIOS 132 and installed by BIOS-resident code during an initial boot process. In another embodiment, a patch from an operating system (OS) vendor may be stored on disk and installed by an OS boot loader later in the boot process. Both embodiments may be combined in the same system.

In one embodiment, patches are delivered over a communications correction (e.g. the Internet) and are received through Comm I/F 160 and stored for use. In other embodiments, patches may be delivered through other means.

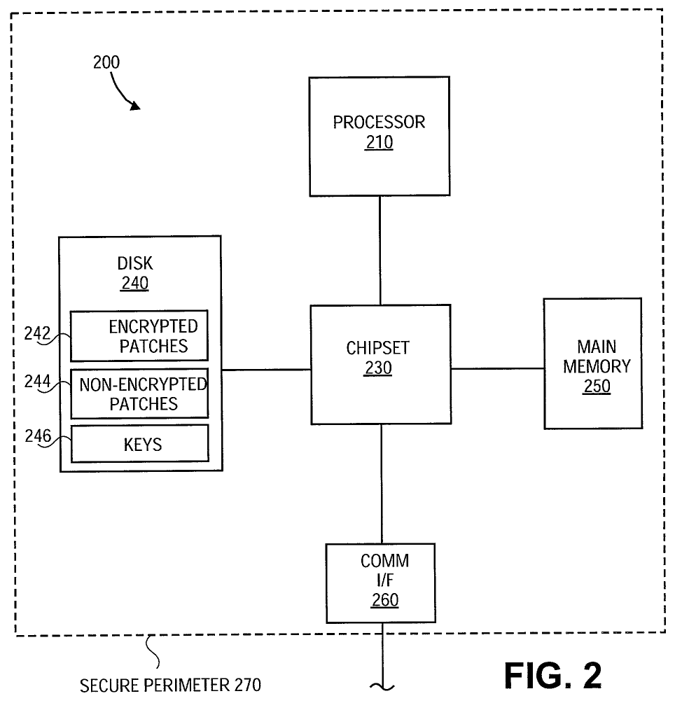

FIG. 2 shows a block diagram of a system to convert patches into a secure form for delivery, according to one embodiment of the invention. In the illustrated embodiment of FIG. 2, system 200 includes a processor 210, chipset 230, disk 240, main memory 250, and communications interface 260. The basic functions of each of these devices may be similar to their counterparts in FIG. 1. However, as an originator of patches, in one embodiment system 200 is in a protectable centralized installation where protection against attackers may be provided for the overall system 200. In the illustrated embodiment, this protection may be provided by a secure perimeter 270. As used herein, the term “perimeter” is conceptual rather than physical, and secure perimeter 270 may include numerous protective measures, including but not limited to physical protection of the system 200, limited access of personnel to the system 200, a firewall or other protective software device to prevent unauthorized invasion of the system through communications interface 260, etc. System 200 may also utilize internal security features similar to those shown in FIG. 1. In one embodiment, system 200 is used to generate patch packages for a single type of target system. In another embodiment, system 200 is used to generate different patch packages for multiple types of target systems. The code for the patches may either be generated in system 200, or may be generated elsewhere and delivered to system 200 for preparation of the associated patch packages. Information to be used and stored in system 200 may include one or more of, but is not limited to, non-encrypted patches 244, encrypted patches 242, and associated keys 246, all of which are shown stored on disk 240. Since different target systems may require different patches and involve different keys, disk 240 may be segmented into different storage areas, each storage area for a separate set of patches and associated key(s).

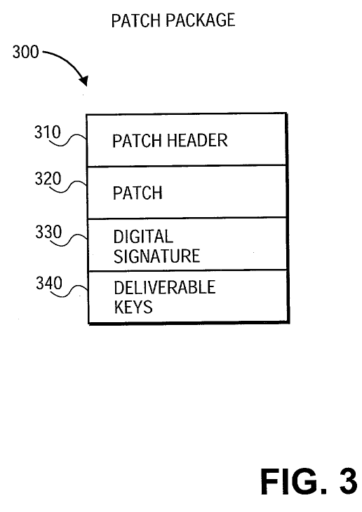

FIG. 3 shows a patch package containing elements deliverable from the system of FIG. 2 to the system of FIG. 1, according to one embodiment of the invention. In one embodiment, a patch package 300 includes a patch header 310, a patch 320, and a digital signature 330. Another embodiment may also include one or more deliverable keys 340. The patch header 310 contains identifying information that may identify one or more of, but is not limited to, the following: the type of target system for which the patch is intended, the type of patch, where the patch is to be used, how the patch is to be used, and any other relevant information that may be needed by the target system 100. In one embodiment, patch header 310 is not encrypted, to facilitate identification and disposition of the patch package 300 by the target system 100 before authentication and/or decryption of the patch. Patch 320 contains the microcode for placement in patch memory 114, although patch 320 may be in encrypted form while in patch package 300. Encryption of patch 320 may be used to protect trade secrets or other confidential information that could be derived from the patch itself. Digital signature 330 includes data for validating the authenticity of the patch to be installed, so that a change to the patch after preparation of the patch package may be detected. In one embodiment the digital signature 330 is generated only for patch 320. In another embodiment the digital signature 330 is generated for both the patch 320 and the patch header 310, so that an unauthorized alteration to either may be detected by the target system 100. In still other embodiments, the digital signature 330 may also be generated for other components of patch package 300.

In one embodiment, all keys needed by target system 100 are embedded in processor 110 at the time of manufacture. For a particular such embodiment, patch package 300 does not include any keys to be used in decoding the patch. In another particular embodiment, one or more of the keys to be used by the system 100 are delivered to the system 100 as a part of patch package 300, and are designated herein as deliverable keys 340 (the plural term “keys” also encompasses embodiments having only a single deliverable key). Deliverable keys 340 may be associated with other keys that are used either in target system 100 or origination system 200. For example, in a particular embodiment a deliverable key includes the public key of a public/private key pair in an asymmetric cryptographic algorithm, with the private key remaining in the origination system 200, and a hash value derived from the public key is embedded in processor 100 and is used to validate the authenticity of the delivered public key. An embedded hash value may also be used to validate one or more keys provided through other means, e.g. key(s) placed on disk with an operating system upgrade or placed into BIOS with a BIOS upgrade. Other embodiments may use other combinations of keys and encryption schemes. Each of the elements of patch package 300 is described in more detail later in the disclosure.

In still another embodiment, an embedded key or hash value may be used with a chain of key certificates. In one such embodiment, the embedded key or hash value is used to validate a second key, which is used to validate a third key, etc., thus providing multiple layers of security with each key associated with a particular layer. The keys may be delivered through one or more of the previously mentioned delivery methods, and/or through other methods not described.

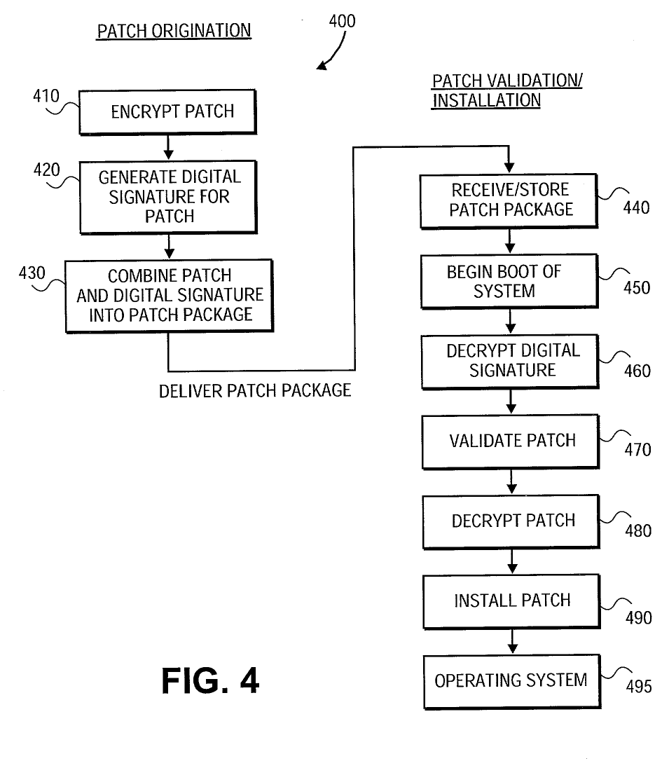

FIG. 4 shows a flowchart of an overall process for preparing, delivering and validating a patch package according to one embodiment of the invention. In the illustrated embodiment of FIG. 4, flowchart 400 has two parts. Blocks 410 through 430 show a patch origination process, in which a patch origination system prepares an existing patch for secure delivery. Blocks 440 through 495 show a patch validation/installation process, which is performed in the target system.

In one embodiment, the patch origination process begins with encrypting the patch at block 410. As previously mentioned, some embodiments may not encrypt the patch because the contents of the patch are not considered confidential and do not need protection. Whether the patch is encrypted or not, the operations of blocks 420 and 430 may be used to permit detection of tampering with the patch before its installation in the target system. At block 420, a digital signature is generated for the patch. In one embodiment, the digital signature is generated for both the patch header and the patch so that neither may be tampered with without detection. In another embodiment, the digital signature is generated for the patch but not the patch header. In still another embodiment the digital signature is also generated for the deliverable keys. At block 430 the digital signature and the patch, along with any other included elements, are combined to form a patch package. If the patch was encrypted at block 410 then the encrypted patch is included at block 430.

After the patch package is created, the patch package may be delivered to the target system through any feasible means. The patch validation/installation process, which takes place in the target system, begins at block 440 with the patch package being received and stored. The patch package may be stored on the disk 140, in the BIOS 132, or in any feasible storage location in target system 100. In one embodiment, patches are not installed in an operational condition until the system is booted, a process which begins at block 450. At block 460, the digital signature from the patch package is decrypted and is used to validate the patch at block 470. Decryption and validation may take any of several forms as described later. If the patch was encrypted at block 410, then it is decrypted at block 480 to expose the actual patch. At block 490, the exposed patch is installed in processor 110 in a manner that makes it operational. At block 495, processor 110 may operate using the patched microcode.

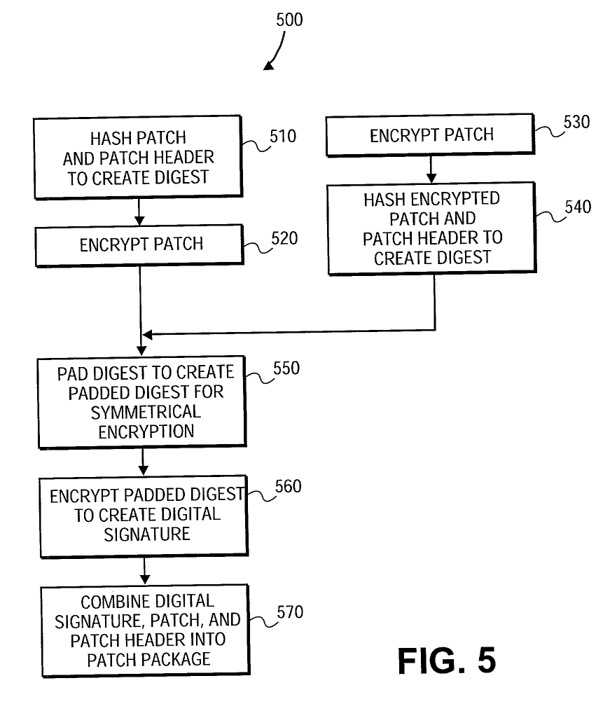

FIG. 5 shows a flowchart of a process for preparing a patch package, according to one embodiment of the invention. Flowchart 500 shows a more detailed description of the patch origination process of FIG. 4. The embodiment shown in FIG. 5 includes an encryption of the patch and the creation of a digest to be used to validate that the received patch is correct. In one embodiment, encryption of the patch is performed with a symmetric encryption algorithm (e.g., AES, DES, etc.) A digest, as used herein, is a parameter obtained by performing an operation on a block of data, in which identical blocks of data produce identical digests, but any change in the block of data is likely to produce a different digest. In one embodiment the digest is a hash digest, i.e., a digest created by applying a hashing algorithm to the patch. In one embodiment the digest is created first and then the patch is encrypted, while in another embodiment the patch is encrypted first and then the digest is created for the encrypted patch. FIG. 5 shows both embodiments. In the first embodiment, at block 510 the unencrypted patch and the patch header are subjected to a hash process to create a digest. In a particular embodiment, the hash process uses the Secure Hash Algorithm (SHA-1), published in 1994 under the Federal Information Publishing Standard FIPS PUB 180-1. Subsequently, at block 520 the patch is encrypted. If the patch is not to be encrypted, block 520 may be omitted. In the second embodiment, at block 530 the patch is encrypted first and at block 540 the encrypted patch and the patch header are subjected to the hash process to create the digest. In either embodiment, if a subsequent operation requires that the digest consist of a certain number of bits, at block 550 the digest may be padded (i.e., data added to it) to increase the number of bits as needed. The pad may consist of predetermined data or random data. At block 560, the padded digest is encrypted to create a digital signature. In one example, the padded digest is encrypted using the private key of a public/private key pair in an asymmetric encryption process. In a particular embodiment, the encryption follows the RSA encryption process using a 2048-bit private key. As is well known, in the RSA encryption process both the key and the encrypted message have the same number of bits, necessitating that the digest be padded at block 550 if the digest is smaller than the key. In another embodiment, the digest and the key are already the same size and the padding at block 550 may be eliminated. In still another embodiment, an encryption method is used in which the key and the message do not need to be the same size, in which case the padding at block 550 may also be eliminated. At block 570, the digital signature, the patch (encrypted or not encrypted) and the patch header are combined into a patch package for a delivery to the target system. In one embodiment, the patch package may also include other information, depending on the requirements of the system.

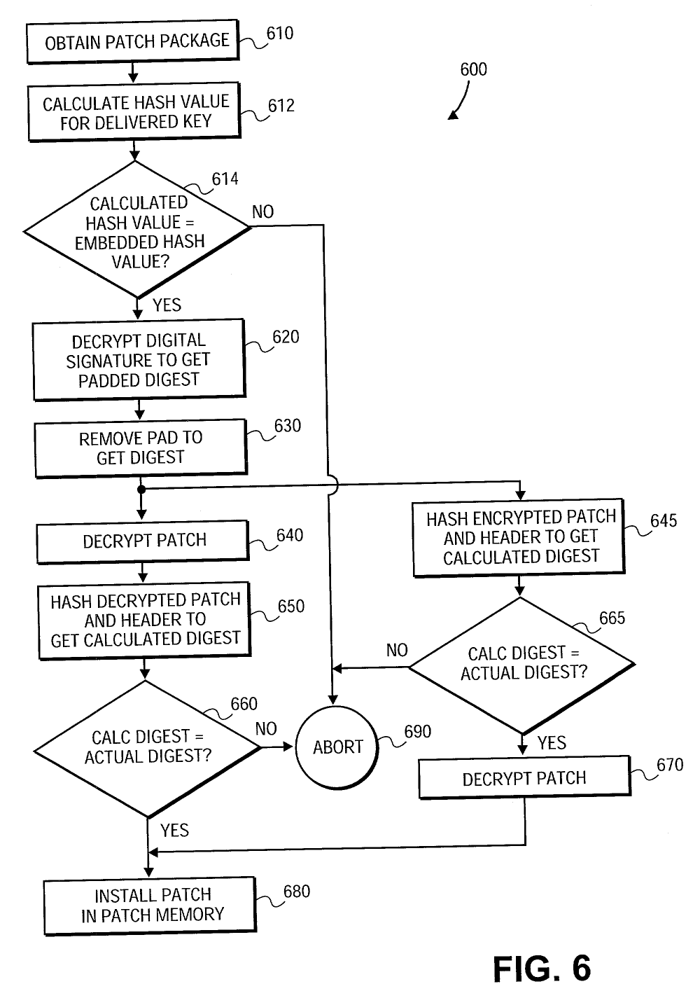

FIG. 6 shows a flowchart of a process for validating a patch package, according to one embodiment of the invention. Flowchart 600 shows a more detailed description of the patch validation and installation process of FIG. 4. At block 610, the patch package is obtained from within the target system. In one embodiment the patch package was previously received by the target system and placed in storage, and is obtained from that storage. In another embodiment the patch package is obtained at block 610 as soon as it is received by the target system, without intermediate storage. While in one embodiment the entire patch package as delivered by the originating system is obtained, in another embodiment any unnecessary elements of the package are stripped away before the patch package is obtained.

In one embodiment in which a key is delivered in the patch package, a hash value may be calculated for the key at block 612. If this calculated hash value matches an associated hash value embedded in processor 110, then the key has been validated and may be used in subsequent validation operations. If the calculated hash value does not match the embedded hash value, then validation fails and control may move to block 690, which is described later. In an embodiment that does not involve a delivered key, the operations of blocks 612 and 614 may be omitted.

At block 620, the digital signature is decrypted to obtain the digest created in the originating system. In one embodiment, the digital signature was generated with an asymmetric encryption algorithm using the private key of a public/private key pair, and the decryption of block 620 is performed using the associated public key. If the digest was padded during creation, then the operation of block 620 obtains the padded digest, and at block 630 the pad is removed to expose the digest that was previously generated in block 510 or block 540. If the digest was not padded during creation, then the operation of block 620 produces the non-padded digest, and block 630 may be omitted.

At this point, the process followed depends on whether the digest was created before or after the patch was encrypted in flowchart 500. In an embodiment in which the digest was created before encryption as shown in blocks 510 and 520, then at block 640 the patch is decrypted and a hash function is performed on the decrypted patch and patch header at block 650 to get a calculated digest. At block 660 the calculated digest is compared with the actual digest obtained in blocks 620-630 to see if the two digests match. If the two digests are equivalent, then the patch has been validated and the patch may be installed at block 680. In one embodiment, installing the patch includes placing the patch into the patch memory 114 of processor 110 in such a manner that any attempted access to the patched microcode will be directed to the patch memory 114 rather than to the original microcode 112.

Returning to block 630, in an embodiment in which the patch was encrypted before creation of the digest at blocks 530 and 540, at block 645 the encrypted patch and header may be subjected to a hash operation to get the calculated digest. At block 665, the calculated digest may be compared with the actual digest uncovered at block 630 to see if they match. If they are found to be equivalent, then the patch has been validated and the patch may be decrypted at block 670. The validated and decrypted patch may then be installed at block 680. In both embodiments, the hash operation used at blocks 645, 650 is the same hash operation that was used at blocks 510, 540.

If the calculated digest does not match the actual digest at either block 660 or block 665, this indicates that the patch package has been altered since its creation or is otherwise unsuitable for installation. Such alteration/unsuitability may have several causes, including but not limited to: a deliberate attempt by an unauthorized person to change the patch, an undetected/uncorrected data transmission error during delivery, delivery of the patch package to an incorrect target system, software or hardware failure, or human error. Regardless of the cause, if the actual digest does not match the calculated digest, the patch installation process may be aborted at block 690 by not installing the non-validated patch. Aborting the patch installation may take several forms, including but not limited to: 1) attempting to reinstall the patch, 2) skipping the defective patch but installing other patches, 3) reverting to a previous version of the patch, 4) shutting the system down, 5) rebooting the system, 6) etc.

In one embodiment, the validation process of blocks 610-670 is performed for the entire patch in secure memory 118, and after validation the entire patch is installed in patch memory 114 at block 680. In another embodiment, in which secure memory 118 does not have enough capacity to perform the entire validation process, the validation process of blocks 610-670 may be performed incrementally on separate portions of the patch. If any portion is not validated in this manner, the process may be aborted at block 690 as previously described. If all portions are validated in this manner, the patch may be validated incrementally a second time, with each portion being installed in patch memory 114 as it is validated. If any portion of the patch is not validated on the second pass (which could indicate it was tampered with after the first validation), the process may be aborted at block 690. If the patch has been partially installed before being aborted at block 690, the abort process of block 690 may include removing the newly-installed patch from patch memory 114, in addition to one or more of the previously listed abort processes.

The foregoing description is intended to be illustrative and not limiting. Variations will occur to those of skill in the art. Those variations are intended to be included in various embodiments of the invention, which are limited only by the spirit and scope of the appended claims.

What is claimed is:

1. A machine-readable medium that provides instructions, which when executed by a set of one or more processors, cause said set of processors to perform operations comprising:
generating a hash digest for a microcode patch;
encrypting the hash digest to generate a digital signature; and
combining the digital signature and the microcode patch for delivery to a target processor to patch microcode in the target processor.

2. The medium of claim 1, wherein:
said combining includes combing a key with the digital signature and the microcode patch for the delivery to the target processor.

3. The medium of claim 1, wherein:
said combining includes combining a hash value of a key with the digital signature and the microcode patch for the delivery to the target processor.

4. A method, comprising:
generating a hash digest for a microcode patch;
encrypting the hash digest with a private key for an asymmetric cryptographic algorithm to generate a digital signature; and
combining the digital signature and the microcode patch for delivery to a processor to patch microcode of the processor.

5. The method of claim 4, further comprising:
encrypting the microcode patch;
wherein said generating the hash digest includes generating the hash digest before said encrypting the microcode patch; and
wherein said combining includes combining the digital signature with the encrypted microcode patch.

6. The method of claim 4, further comprising:
encrypting the microcode patch;
wherein said generating the hash digest includes generating the hash digest after said encrypting the microcode patch; and
wherein said combining includes combining the digital signature with the encrypted microcode patch.

7. A machine-readable medium containing data comprising:
a microcode patch to patch microcode in a target system; and
a digital signature produced by encrypting a digest created by performing a hash operation on the microcode patch.

8. The medium of claim 7, wherein the data further comprises:
a key to decrypt the digital signature to produce the digest.

9. The medium of claim 7, wherein the data further comprises:
a hash value of a key to validate the microcode patch.

10. The medium of claim 7, wherein:
the microcode patch is encrypted.

11. An apparatus, comprising:
a processor having microcode;
a secure memory coupled to the processor to decode an encoded microcode patch; and
a microcode patch memory coupled to the microcode to contain the decoded microcode patch.

12. The apparatus of claim 11, wherein:
the microcode includes microinstructions to decode the encoded microcode patch; and
the secure memory is to contain at least one of the encoded microcode patch, the decoded microcode patch, and interim products during decoding of the microcode patch.

13. The apparatus of claim 11, wherein:
the microcode includes microinstructions to decode the encoded microcode patch; and
the secure memory is to simultaneously contain no more than a portion of at least one of the encoded microcode patch, the decoded microcode patch, and interim products during decoding of the microcode patch.

14. The apparatus of claim 11, wherein:
the processor includes an embedded key to use to decode the encoded microcode patch.

15. The apparatus of claim 14, wherein:
the embedded key is a public key in an asymmetric cryptographic algorithm.

16. A method, comprising:
obtaining a microcode patch and an associated digital signature;
decrypting the digital signature in a secure memory to obtain a first hash digest;
calculating a second hash digest with the microcode patch;
comparing the first hash digest with the second hash digest; and
installing the microcode patch in a microcode patch memory responsive to a match between the first and second hash digests.

17. The method of claim 16, further comprising:
decrypting the microcode patch;
wherein said calculating the second hash digest includes calculating the second hash digest with an encrypted version of the microcode patch.

18. The method of claim 16, further comprising:
decrypting the microcode patch;
wherein said calculating the second hash digest includes calculating the second hash digest with a decrypted version of the microcode patch.

19. The method of claim 16, wherein:
said decrypting the digital signature includes performing an asymmetric decryption using a public key.

20. The method of claim 16, wherein:
said decrypting the digital signature includes using an embedded key.

21. The method of claim 16, wherein:
said decrypting the digital signature includes performing an asymmetric decryption using a key provided with the microcode patch.

22. A machine-readable medium that provides instructions, which when executed by a set of one or more processors, cause said set of processors to perform operations comprising:
obtaining a microcode patch and an associated digital signature;
decrypting the digital signature to obtain a first hash digest;
calculating a second hash digest with the microcode patch;
comparing the first hash digest with the second hash digest; and
installing the microcode patch responsive to a match between the first hash digest and the second hash digest.

23. The medium of claim 22, further comprising:
decrypting the microcode patch;
wherein said calculating the second hash digest includes calculating the second hash digest with an encrypted version of the microcode patch.

24. The medium of claim 22, further comprising:
decrypting the microcode patch;
wherein said calculating the second hash digest includes calculating the second hash digest with a decrypted version of the microcode patch.

25. The medium of claim 22, wherein:
said decrypting the digital signature includes performing an asymmetric decryption using a public key.

26. The medium of claim 22, wherein:
said decrypting the digital signature includes performing an asymmetric decryption using an embedded key.

27. The method of claim 22, wherein:
said decrypting the digital signature includes performing an asymmetric decryption using a key provided with the microcode patch and the associated digital signature.

28. A system, comprising:
a processor having microcode and an embedded key; and
a microcode patch package residing in at least one of a storage device and a basic input-output system coupled with the processor, the microcode patch package including a microcode patch to patch the microcode and a digital signature to validate the microcode patch using the embedded key.

29. The system of claim 28, wherein:
the microcode patch is in an encrypted form in the microcode patch package.

30. The system of claim 28, further comprising:
a secure memory to contain the microcode patch during validation.
